(19) United States
(12) Patent Application Publication
(10) Pub. No.: US 2008/0094712 A1
(43) Pub. Date: Apr. 24, 2008

(54) Close-Bonded Diffractive Optical Element, Optical Material Used Therefore, Resin Precursor And Resin Precursor Composition

(75) Inventor: Akiko Miyakawa, Kanagawa-ken (JP)

Correspondence Address: STAAS & HALSEY LLP, SUITE 700, 1201 NEW YORK AVENUE, N.W., WASHINGTON, DC, 20005, US

(73) Assignee: NIKON CORPORATION, Chiyoda-Ku, Tokyo (JP)

(21) Appl. No.: 11/793,308

(22) PCT Filed: Dec. 20, 2005
(86) PCT No.: PCT/JP05/23363

§ 371 Date: Jun. 19, 2007

(30) Foreign Application Priority Data
Dec. 20, 2004 (JP) 2004-367608
Aug. 18, 2005 (JP) 2005-237573

(51) Int. Cl. G02B 5/18; C08F 2/46

(52) U.S. Cl. 359/566; 522/182

(57) ABSTRACT

A close-contact multi-layer type diffractive optical element having a homogeneous low-refractive-index and high-dispersion resin layer is produced with satisfactory workability. Among two optical members constituting a diffractive plane, a low-refractive-index and high-dispersion member is formed, using a resin precursor composition containing bifunctional fluorine-containing (meth)acrylate and bifunctional (meth)acrylate having a fluorene structure.

### BACKGROUND OF THE INVENTION

The present invention relates to a close-contact multi-layer type diffractive optical element, a preferable low-refractive-index and high-dispersion UV-curable resin, a precursor, and a composition containing the precursor.

A close-contact multi-layer type diffractive optical element, in which two optical members made of an optical material are in close contact with each other and an interface therebetween constitutes a diffraction grating, has advantages in that usage wavelength can be enlarged, and it is easy to align gratings.

In the close-contact multi-layer type diffractive optical element, as described in Japanese Patent Laid-open Publication No. H09-127322 A, for example, the optical characteristics of two optical members sandwiching a diffractive optical plane are required to have a high-refractive-index and low-dispersion, and a low-refractive-index and high-dispersion, relative to each other. As a general already-existing high-refractive-index and low-dispersion optical material, glass, for example, can be used. Regarding two optical members of the close-contact multi-layer type diffractive optical element, in the case where one of the optical members is made of high-refractive-index and low-dispersion glass, it is required that the other optical member be made of a low-refractive-index and high-dispersion optical material relative to the above glass.

As an optical material used in the optical member of the close-contact multi-layer type diffractive optical element, a resin is suitable since the resin is capable of reducing weight of the element and production of the element can be realized at a low cost with mass-productivity enhanced. In particular, a UV-curable resin is desirable because it has excellent transferability, takes a short time for curing, does not require a heat source, and the like, which can further reduce the cost. However, in a resin conventionally used in an optical field, it is difficult to realize special optical characteristics of high dispersion while having a low refractive index.

### SUMMARY OF THE INVENTION

Thus, an object of the present invention is to provide a low-refractive-index and high-dispersion UV-curable resin preferable for an optical material used in a close-contact multi-layer type diffractive optical element, a precursor thereof, a composition containing the precursor, and a close-contact multi-layer type diffractive optical element using these.

In order to achieve the above object, the inventors of the present invention have investigated, with regard to resins having various structures, the relationship between the chemical structure and composition, and between the refractive index and dispersion, and have found that a resin containing fluorine atoms has a small refractive index. The inventors have also found that a resin having an aromatic ring has a high-dispersion. Thus, it is considered that a UV-curable resin having both these structures may be used. However, generally, a resin containing fluorine atoms has poor compatibility with another resin. Therefore, when the resin containing fluorine atoms is used, irregularities in refractive index occur in the resin, and the resin does not become optically uniform, which degrades optical characteristics. For example, the inventors of the present invention attempted to produce an optical element, using trifluoroethyl(meth)acrylate (CH₂═CR—COO—CH₂—CF₃; R═H or CH₃) and perfluorooctylethyl(meth)acrylate (CH₂═CR—COO—CH₂CH₂(CF₂)₈F; R═H or CH₃), which is easily available monofunctional fluorine-containing acrylate. However, an optical element having desired optical characteristics was not obtained. Further, the cured substance did not have a desired strength.

The inventors of the present invention studied extensively how to solve the above problem, and found that the use of bifunctional acrylate and/or methacrylate (hereinafter, referred to simply as (meth)acrylate) containing fluorine atoms and bifunctional (meth)acrylate having a fluorene structure, enables a homogeneous low-refractive-index and high-dispersion resin layer to be formed, thereby achieving the present invention.

The functional mechanism by which the compatibility is enhanced by using bifunctional fluorine-containing (meth)acrylate is not clear. However, having two polar groups (an acryloyl group or a methacryloyl group) rich in π-electrons in molecules is considered to have some influence on intermolecular force.

Further, a fluorene structure containing a large amount of aromatic rings is effective for realizing high-dispersion characteristics; however, it generally has very high viscosity, and hence has poor workability. However, according to the present invention, by using bifunctional fluorine-containing (meth)acrylate with low viscosity, an excellent resin precursor composition can be realized, which has a high-dispersion while having a low-refractive-index, and further, has high workability due to appropriate viscosity.

The present invention provides a resin precursor composition (first resin precursor composition) containing bifunctional fluorine-containing (meth)acrylate, bifunctional (meth)acrylate having a fluorene structure, and a photopolymerization initiator;

a UV-cured resin obtained by curing the resin precursor composition; and

a close-contact multi-layer type diffractive optical element which comprising two optical members that are in close contact with each other, in which an interface between the optical members constitutes a diffraction grating, and one of the optical members is made of the UV-cured resin (first resin).

It is desirable that the other of the optical members be made of a second resin that is a cured substance of a second resin precursor composition containing an acrylate-terminated oligomer obtained by allowing excess bifunctional acrylate to react with bifunctional thiol and a photopolymerization initiator.

Further, according to the present invention, there is provided an acrylic resin which is a copolymer having a first repetition unit represented by the following general formula (Chemical Formula 1a) and a second repetition unit represented by the following general formula (Chemical Formula 1b): 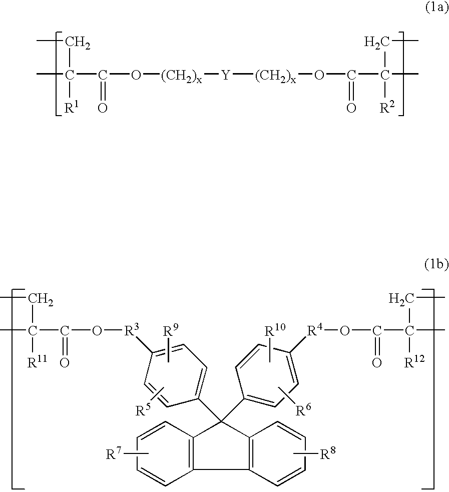
where R¹ and R² each represent a hydrogen atom or a methyl group, R³ and R⁴ each represent —((CH₂)ₚO)ₘ— or —(CH₂CH(OH)CH₂O)ₘ— (where m represents an integer of 1 to 3, and p represents an integer of 2 to 4), R⁵ to R¹⁰ each represent a hydrogen atom, a fluorine atom, a hydrocarbon group containing 1 to 6 carbon atoms, a phenyl group, a phenyl fluoride group, and a phenyl group with a hydrocarbon group containing 1 to 6 carbon atoms substituted, and R¹¹ to R¹² each represent a hydrogen atom or a methyl group, x represents an integer of 1 to 2, and Y represents a perfluoroalkyl group containing 2 to 12 carbon atoms or —(CF₂—O—CF₂)_{z}—, where z represents an integer of 1 to 4.

Further, according to the present invention, there are provided an optical material for a close-contact multi-layer type diffractive optical element in which a refractive index n_{d} at a wavelength of 587.56 nm of a d-line is 1.54 or less, and an mean dispersion, i.e., a difference (n_{F}−n_{C}) between a refractive index n_{F} at a wavelength of 486.13 nm of an F-line and a refractive index n_{C} at a wavelength of 656.27 nm of a C-line is 0.0145 or more, and a resin precursor composition for a close-contact multi-layer type diffractive optical element in which a refractive index n_{d} of a cured resin is 1.54 or less and an mean dispersion (n_{F}−n_{C}) of the cured resin is 0.0145 or more.

According to the present invention, while a low-refractive-index is realized by using bifunctional fluorine-containing (meth)acrylate to allow fluorine atoms to be present in molecules, and a high-dispersion is realized by using bifunctional (meth)acrylate having a fluorene structure, a homogeneous low-refractive-index and high-dispersion resin layer can be formed. Further, appropriate viscosity of the resin precursor composition can also be provided, so a close-contact multi-layer type diffractive optical element excellent in optical characteristics can be produced with good workability.

### BRIEF DESCRIPTION OF THE DRAWINGS

In the accompanying drawings:

FIG. 1 is an explanatory view illustrating production steps of a close-contact multi-layer type diffractive optical element of Example 1;

FIG. 2 is an IR spectrum of a resin precursor composition “a”;

FIG. 3 is an IR spectrum of a resin precursor composition “b”;

FIG. 4 is an IR spectrum of a resin precursor composition “c”;

FIG. 5 is an IR spectrum of a cured substance of the resin precursor composition “a”;

FIG. 6 is an IR spectrum of a cured substance of the resin precursor composition “b”; and

FIG. 7 is an IR spectrum of a cured substance of the resin precursor composition “c”.

### DESCRIPTION OF THE PREFERRED EMBODIMENTS

In a close-contact multi-layer type diffractive optical element, the optical characteristics of optical members sandwiching a diffractive optical plane are required to have a high-refractive-index and low-dispersion, and a low-refractive-index and high-dispersion relative to each other. Herein, as a high-refractive-index and low-dispersion optical material, low-melting glass is used in most cases. In this case, a diffractive plane is molded on glass by glass molding, and a UV-curable resin is stacked on the diffractive plane, and accordingly a close-contact multi-layer type diffractive optical element can be produced. As one of low-melting glass materials used for such an application, there is K-PSK60 (produced by Sumita Optical glass, Inc.).

Assuming that the refractive indexes at a wavelength of λ₀ of a high-refractive-index and low-dispersion material, and a low-refractive-index and high-dispersion material, are n_{1(λ0)} and n_{2(λ0)}, respectively, a grating height d₀ optimized so that an moth-order diffraction efficiency becomes 100% at the wavelength of λ₀ is expressed as follows.
(n_{1(λ0)}−n_{2(λ0)})×d₀=m₀×λ₀
Specifically, the grating height d₀ is inversely proportional to the refractive index difference between the high-refractive-index and low-dispersion material and the low-refractive-index and high-dispersion material.

Further, assuming that a={(n1−1)d−(n2−1)d}/λ, an mth-order diffraction efficiency ηₘ is expressed as follows:
ηₘ={sin(a−m)π/(a−m)π}²

In general, it is desirable that the diffractive optical element have a low grating height so as to reduce angle of view dependency, and have a high diffraction efficiency over a use wavelength range so as to decrease flare. Thus, when K-PSK60 is combined with the low-refractive-index and high-dispersion resin (nd=1.54, nF−nC=1.5502−1.5367=0.0145), it is understood that a close-contact multi-layer type diffractive optical element can be realized, which has a low grating height (11.55 μm), and an excellent diffraction efficiency of 95% or more over a visible light range: 95% at an F-line (wavelength: 486.13 nm), 100% at a d-line (wavelength: 587.56 nm), and 98% at a C-line (wavelength: 656.27 nm).

It is desirable that the refractive index n_{d} of the first resin in the present invention be 1.54 or less, and the mean dispersion (n_{F}−n_{C}) of the first resin be 0.0145 or more. Further, it is further desirable that the refractive index n_{d} of the second resin is 1.55 or more, and the mean dispersion (n_{F}−n_{C}) of the second resin is 0.013 or less, because a close-contact multi-layer diffractive optical element using resin in all the optical members having satisfactory optical characteristics of low grating height and high diffraction efficiency, which has not been realized conventionally, can be obtained.

The first resin precursor composition of the present invention contains bifunctional fluorine-containing (meth)acrylate, bifunctional (meth)acrylate having a fluorene structure, and a photopolymerization initiator. As the content of the bifunctional fluorine-containing (meth)acrylate is increased, the refractive index is decreased, while the dispersion is decreased. On the other hand, when the content of the bifunctional (meth)acrylate having a fluorene structure is increased, the dispersion is increased, while the refractive index is increased. In order to obtain optical characteristics of low-refractive-index and high-dispersion preferable for the close-contact multi-layer type diffractive optical element, it is desirable that the content of bifunctional fluorine-containing (meth)acrylate be 10 to 80 wt %, and the content of bifunctional (meth)acrylate having a fluorene structure be 10 to 80 wt %.

As the bifunctional fluorine-containing (meth)acrylate preferable for the present invention, there is a compound represented by the following structural formula (Chemical Formula 2).

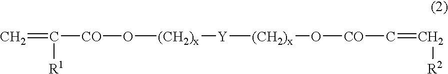

where R¹ and R² each represent a hydrogen atom or a methyl group, x represents an integer of 1 to 2, Y represents a perfluoroalkyl group containing 2 to 12 carbon atoms or —(CF₂—O—CF₂)_{z}—, and z represents an integer of 1 to 4.

Specific examples of the fluorine-containing (meth)acrylate to be used include 1,4-di(meth)acryloyloxy-2,2,3,3-tetrafluorobutane, 1,6-di(meth)acryloyloxy-3,3,4,4-tetrafluorohexane, 1,6-di(meth)acryloyloxy-2,2,3,3,4,4,5,5-octafluorohexane, 1,8-di(meth)acryloyloxy-3,3,4,4,5,5,6,6-octafluorooctane, 1,8-di(meth)acryloyloxy-2,2,3,3,4,4,5,5,6,6,7,7-dodecafluoro octane, 1,9-di(meth)acryloyloxy-2,2,3,3,4,4,5,5,6,6,7,7,8,8-tetradecafluorononane, 1,10-di(meth)acryloyloxy-2,2,3,3,4,4,5,5,6,6,7,7,8,8,9,9-hexadecafluorodecane, and 1,12-di(meth)acryloyloxy-2,2,3,3,4,4,5,5,6,6,7,7,8,8,9,9,10,10,11,11-icosafluorododecane. More specifically, ethyleneoxide-modified bisphenol-F di(meth)acrylate, propyleneoxide-modified bisphenol-F di(meth)acrylate, and the like can be used as fluorine-containing (meth)acrylate.

As the bifunctional fluorine-containing (meth)acrylates, a single compound or a combination of at least two kinds of compounds may be used.

As the bifunctional (meth)acrylate having a fluorene structure, there is a compound represented by the following general formula (Chemical Formula 3), for example. As the bifunctional (meth)acrylates having a fluorene structure, a single compound or a combination of at least two kinds of compounds may be used.

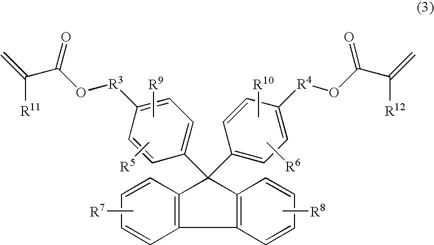

where R³ and R⁴ each represent —((CH₂)ₚO)ₘ— or —(CH₂CH(OH)CH₂O)ₘ— (where m represents an integer of 1 to 3, and p represents an integer of 2 to 4), and R⁵ to R¹⁰ each represent a hydrogen atom, a fluorine atom, a hydrocarbon group containing 1 to 6 carbon atoms, a phenyl group, a phenyl fluoride group, and a phenyl group with a hydrocarbon group containing 1 to 6 carbon atoms substituted, and R¹¹ to R¹² each represent a hydrogen atom or a methyl group).

The first resin precursor composition of the present invention can contain, as a third component separate from the above-mentioned two acrylates, monofunctional to tetrafunctional (meth)acrylate copolymerizable with the above-mentioned two acrylates, if required. This enables the viscosity to be adjusted, and enhances the transparency of a cured substance.

It is desirable that the monofunctional to tetrafunctional (meth)acrylate to be contained as the third component does not contain sulfur, chlorine, bromine, iodine, nor an alicylic structure, in its molecules. This is because the dispersion is decreased when these atoms or structures are contained. Further, it is desirable that the addition amount of monofunctional to tetrafunctional (meth)acrylate be set to be 40% or less, so as to obtain optical characteristics of low-refractive-index and high-dispersion.

Hereinafter, examples of the monofunctional to tetrafunctional (meth)acrylate that can be contained as the third component will be illustrated. However, the present invention is not limited thereto, and one kind or two or more kinds of (meth)acrylates can be selected appropriately.

Examples of the monofunctionalized (meth)acrylate include methyl (meth)acrylate, ethyl (meth)acrylate, butyl (meth)acrylate, isodecyl (meth)acrylate, lauryl (meth)acrylate, tridecyl (meth)acrylate, cetyl (meth)acrylate, stearyl (meth)acrylate, tert-butyl (meth)acrylate, 2-ethylhexyl (meth)acrylate, 2-hydroxybutyl (meth)acrylate, 2-hydroxyethyl (meth)acrylate, 2-hydroxypropyl (meth)acrylate, 3-methoxybutyl (meth)acrylate, diethylaminoethyl (meth)acrylate, phenoxypolyethylene glycol (meth)acrylate, isostearyl (meth)acrylate, paracumylphenoxyethylene glycol (meth)acrylate, dimethylaminoethyl (meth)acrylate, 2-ethylhexylcarbitol (meth)acrylate, butoxyethyl (meth)acrylate, ethoxydiethylene glycol (meth)acrylate, lauroxypolyethylene glycol (meth)acrylate, polyethylene glycol (meth)acrylate, polypropylene glycol (meth)acrylate, acryloxypolyethylene glycol (meth)acrylate, stearoxypolyethylene glycol (meth)acrylate, octoxypolyethylene glycol-polypropylene glycol (meth)acrylate, poly(propylene glycol-tetramethylene glycol) (meth)acrylate, poly(ethylene glycol-tetramethylene glycol) (meth)acrylate, poly(ethylene glycol-propylene glycol) (meth)acrylate, polypropylene glycol (meth)acrylate, methoxypolyethylene glycol (meth)acrylate, methoxypolypropylene glycol (meth)acrylate, and benzyl (meth)acrylate.

Examples of the bifunctionalized (meth)acrylate include 2-ethyl, 2-butyl-propanediol (meth)acrylate, 1,3-butylene glycol di(meth)acrylate, 1,6-hexanediol di(meth)acrylate, 1,9-nonanediol di(meth)acrylate, 1,10-decanediol di(meth)acrylate, neopentyl glycol di(meth)acrylate, dipropylene glycol di(meth)acrylate, glycerol di(meth)acrylate, ethyleneoxide-modified neopenthyl glycol di(meth)acrylate, propyleneoxide-modified neopenthyl glycol di(meth)acrylate, ethyleneoxide-modified bisphenol-A di(meth)acrylate, propyleneoxide-modified bisphenol-A di(meth)acrylate, ethyleneoxide propyleneoxide-modified bisphenol-A di(meth)acrylate, polypropylene glycol (meth)acrylate, and butylethylpropanediol di(meth)acrylate.

Examples of the trifunctionalized (meth)acrylate include tris(acryloxyethyl)isocyanurate, tris(methacryloxyethyl)isocyanurate, epichlorohydrin-modified glycerol triacrylate, ethyleneoxide-modified glycerol triacrylate, propyleneoxide-modified glycerol triacrylate, caprolactone-modified trimethylolpropane triacrylate, ethyleneoxide-modified trimethylolpropane triacrylate, propyleneoxide-modified trimethylolpropane triacrylate, pentaerythritol triacrylate, trimethylolpropane triacrylate, and trimethylolpropane trimethacrylate.

Examples of the tetrafunctionalized (meth)acrylate include pentaerythritol tetraacrylate, dipentaerythritolhydroxy pentaacrylate, and ditrimethylolpropane tetraacrylate.

Among them, as the acrylate to be contained as the third component, phenoxyethylene glycol acrylate, methoxydiethylene glycol methacrylate, benzylmethacrylate, or methoxytripropylene glycol acrylate, which is monofunctional (meth)acrylate; or neopentyl glycol diacrylate or tripropylene glycol diacrylate, which is bifunctional (meth)acrylate, is preferable.

The photopolymerization initiator contained in the resin precursor composition of the present invention is not particularly limited, and one usually used in a UV-curable resin can be selected appropriately.

The curing step during molding of a resin can be conducted in vacuum so as to prevent air bubbles from being mixed. However, when a portion of the components is evaporated in such a case, the composition becomes nonuniform. Thus, it is preferable that the molecular weights of all the resin precursor compositions (excluding the photopolymerization initiator) be 180 or more.

### Example 1

### A. Preparation of a Low-Refractive-index and High-Dispersion Resin Precursor Composition

(1) Preparation of Resin Precursor Composition “a”

First, 57 parts by weight of 2,2,3,3,4,4,5,5-octafluorohexane-1,6-diacrylate that is bifunctional fluorine-containing acrylate, 43 parts by weight of 9,9-bis[4-(2-acryloyloxyethoxy)phenyl]fluorene that is bifunctional acrylate having a fluorene structure, and 0.5 wt % of IRGACURE 184 (Ciba Specialty Chemicals) that is a photopolymerization initiator were mixed to obtain a resin precursor composition “a”.

(2) Resin Precursor Composition “b”

First, 53 parts by weight of 2,2,3,3,4,4,5,5-octafluorohexane-1,6-diacrylate that is bifunctional fluorine-containing acrylate, 42 parts by weight of 9,9-bis[4-(2-acryloyloxyethoxy)phenyl]fluorene that is bifunctional acrylate having a fluorene structure, 5 parts by weight of 2-phenoxyethylene glycol acrylate that is monofunctional acrylate, and 0.5 wt % of IRGACURE 184 (Ciba Specialty Chemicals) that is a photopolymerization initiator were mixed to obtain a resin precursor composition “b”.

(3) Preparation of Resin Precursor Composition “c”

First, 52 parts by weight of 2,2,3,3,4,4,5,5-octafluorohexane-1,6-diacrylate that is bifunctional fluorine-containing acrylate, 43 parts by weight of 9,9-bis[4-(2-acryloyloxyethoxy)phenyl]fluorene that is bifunctional acrylate having a fluorene structure, 5 parts by weight of methoxypolypropylene glycol acrylate that is monofunctional acrylate, and 0.5 wt % of IRGACURE 184 (Ciba Specialty Chemicals) that is a photopolymerization initiator were mixed to obtain a resin precursor composition “c”.

(4) Preparation of a Resin

The obtained resin precursor compositions a to c were respectively cured by irradiation of UV-rays at 8000 mJ/cm², and the refractive indexes thereof were measured. It was found that optical characteristics preferable for a low-refractive-index and high-dispersion optical member of a close-contact multi-layer type diffractive optical element as shown in Table 1 were realized. The cured substances were optically uniform, and defects in outer appearance caused by the nonuniformity of the compositions were not found.

TABLE 1

| | | Mean dispersion |
|---|---|---|
| Resin precursor | Refractive index n_{d} | n_{F} − n_{c} |
| composition | (22.5° C.) | (22.5° C.) |
| a | 1.528 | 0.0150 |
| b | 1.528 | 0.0150 |
| c | 1.528 | 0.0150 |

The resin obtained by curing the resin precursor composition “a” is considered to be a net-shaped random copolymer having two repetition units represented by the following structural formula (Chemical Formula 4).

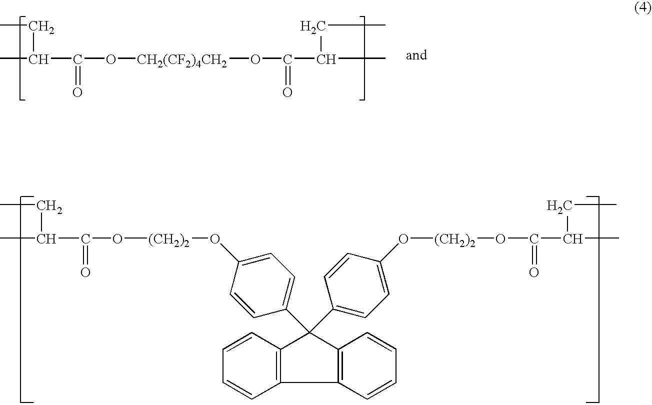

The resin obtained by curing the resin precursor composition “b” is considered to be a net-shaped random copolymer further having a repetition unit represented by the following structural formula (Chemical Formula 5) in addition to two repetition units represented by the above-mentioned structural formula (Chemical Formula 4).

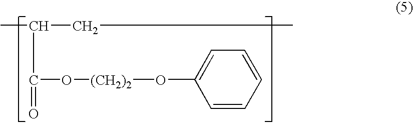

The resin obtained by curing the resin precursor composition “c” is considered to be a net-shaped random copolymer further having a repetition unit represented by the following structural formula (Chemical Formula 6) in addition to two repetition units represented by the above-mentioned structural formula (Chemical Formula 4).

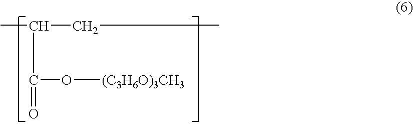

### B. Preparation of a High-Refractive-Index and Low-Dispersion Resin Precursor Composition

Tricyclo[5.2.1.0^{2,6}]decanedimethanol diacrylate that is bifunctional acrylate and di(2-mercaptoethyl)sulfide that is bifunctional thiol were mixed in a molar ratio of bifunctional acrylate:bifunctional thiol=3:1 or 2.5:1. When the mixture became uniform, 0.1 wt % of triethylamine was added as a catalyst, followed by further stirring at room temperature, whereby the viscosity of the mixture increased gradually.

After 4 days, an absorbent TOMITA AD700NS (produced by Tomita Pharmaceutical Co., Ltd.) was added to remove the catalyst, followed by stirring, and the adsorbent was removed by filtration. After that, 0.5 wt % of IRGACURE 184 (Ciba Specialty Chemicals) was added as a photopolymerization initiator, followed by further stirring, whereby UV-curable resin precursor compositions “d” and “e” were obtained. The UV-curable resin precursor compositions had no odor of thiol.

The obtained resin precursor composition was cured by irradiation of UV-rays at 8000 mJ/cm², and the refractive index thereof was measured. It was found that optical characteristics preferable for a high-refractive-index and low-dispersion optical member of a close-contact multi-layer type diffractive optical element as shown in Table 2 were realized. No degradation in characteristics caused by the optical non-homogeneity was found in the cured substance.

TABLE 2

| | | | Mean |
|---|---|---|---|
| | | | dispersion |
| | | | of cured |
| | | Refractive index of | substance |
| Resin precursor | Molar | cured substance n_{d} | n_{F} − n_{c} |
| composition | ratio | (22.5° C.) | (22.5° C.) |
| d | 3:1 | 1.554 | 0.0110 |
| e | 2.5:1 | 1.557 | 0.0110 |

The oligomers thus obtained are considered to be acrylate-terminated oligomers having a structure represented by the following structural formula (Chemical Formula 7). This product contained about 20 mol % of bifunctional acrylate (i.e., unreacted substrate acrylate) represented by the structural formula (Chemical Formula 7) when n=0.

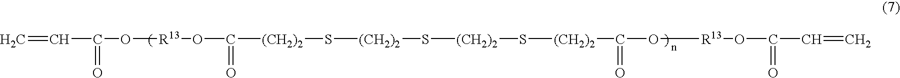

where R¹³ represents a hydrocarbon group having a tricyclo[5.2.1.0^{2,6}]decane skeleton, represented by the following structural formula (Chemical Formula 8), and n represents an integer of 1 to 3.

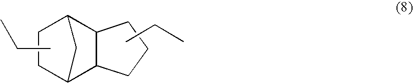

### C. Production of a Close-Contact Multi-Layer Type Diffractive Optical Element

Using the resin precursor composition “a”, “b”, or “c” as the low-refractive-index and high-dispersion resin precursor composition obtained in the above step, and using the resin precursor composition “e” as the high-refractive-index and low-dispersion resin precursor composition obtained in the above step, a close-contact multi-layer type diffractive optical element with an outer diameter of 50 mm and a grating height of 20 μm was produced. The grating pitch of the element was set to be 3.5 mm in the vicinity of the center and 0.17 mm in the vicinity of the outer circumference, whereby the pitch was set so as to be smaller toward the outer circumference (periphery).

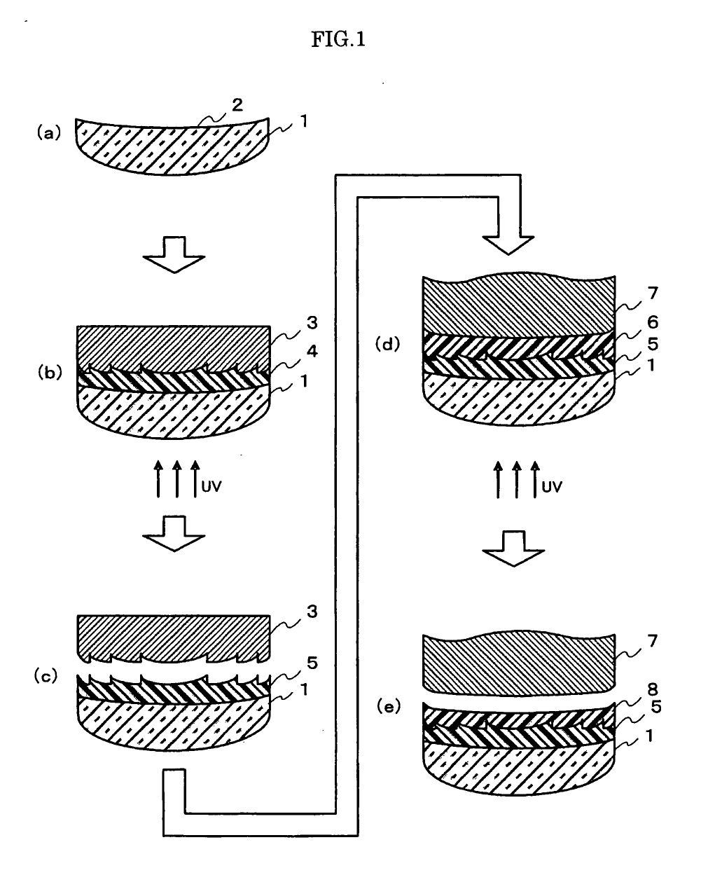

First, a surface 2 of a glass base material 1, on which a resin layer is to be molded, was treated with silane coupling reagent (Step (a) of FIG. 1). Then, as shown in Step (b) of FIG. 1, the treated surface 2 and a mold 3, having the molding surface in a grating shape as described above, were made to oppose each other, and the above-mentioned low-refractive-index and high-dispersion resin precursor composition 4 was applied therebetween. Then, the low-refractive-index and high-dispersion resin precursor composition 4 was cured by irradiation of UV-rays to obtain an optical member 5 made of low-refractive-index and high-dispersion resin, and thereafter the mold 3 was released (Step (c) of FIG. 1). Subsequently, as shown in Step (d) of FIG. 1, the optical member 5 and a mold 7 having a molding surface in a continuous plane shape or a curved surface shape without a diffraction grating were made to oppose each other, and a high-refractive-index and low-dispersion resin precursor composition 6 obtained in the above-mentioned step was applied therebetween. Then, the high-refractive-index and low-dispersion resin precursor composition 6 was cured by irradiation of UV-rays to obtain an optical member 8 made of a high-refractive-index and low-dispersion resin, and thereafter, the mold 7 was released (Step (e) of FIG. 1).

The obtained close-contact multi-layer type diffractive optical element had satisfactory optical characteristics in the case of using either one of the resin precursor compositions.

The resin constituting the optical member 8 formed in the present example is considered to be a net-shaped copolymer having a repetition unit represented by the following structural formula (Chemical Formula 9).

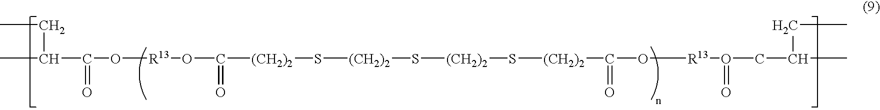

### D. IR Spectra of the Low-Refractive-Index and High-Dispersion Resin Precursor Compositions a to c and the Low-Refractive-Index and High-Dispersion Optical Members “a” to “c” Described in Example 1 were Measured

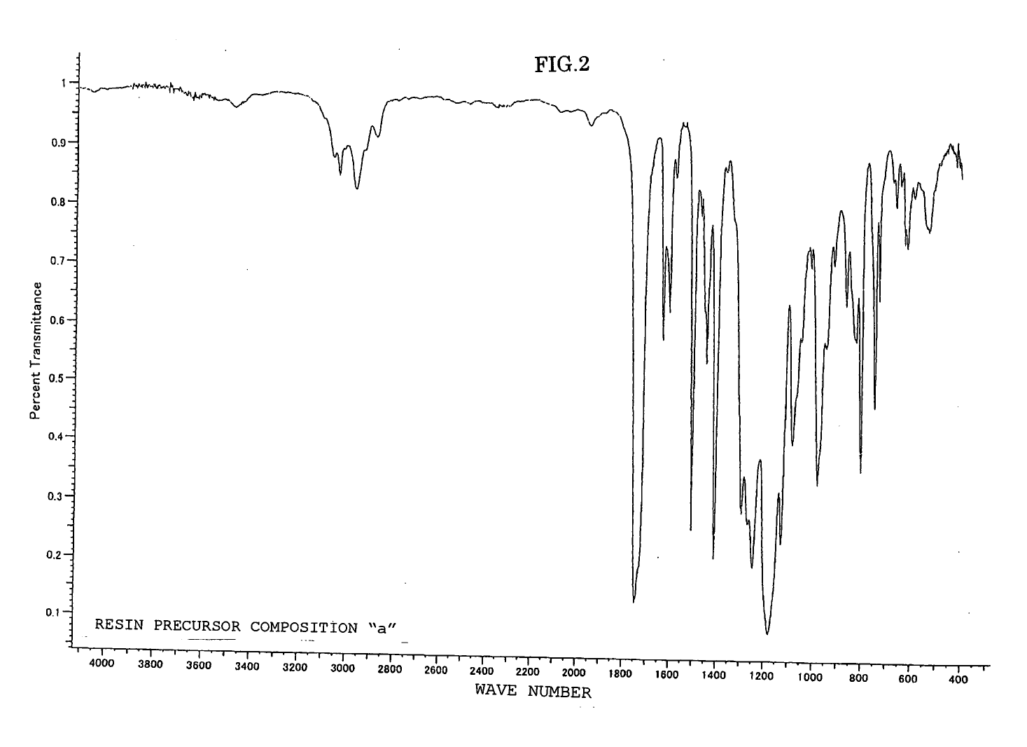

FIG. 2 shows an IR spectrum of the resin precursor composition “a”.

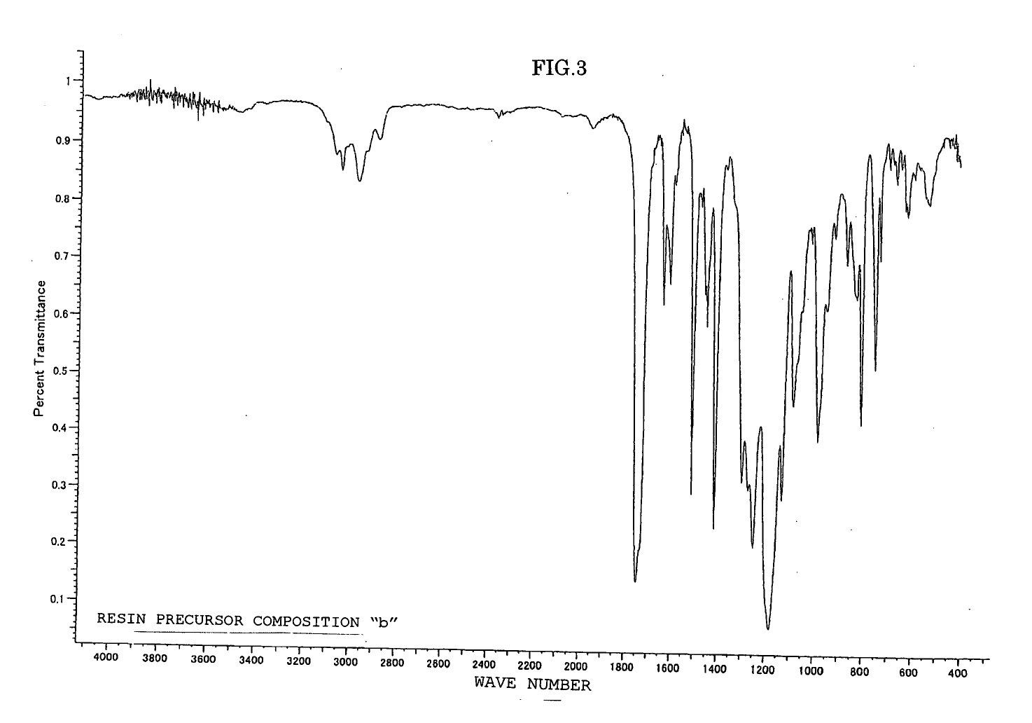

FIG. 3 shows an IR spectrum of the resin precursor composition “b”.

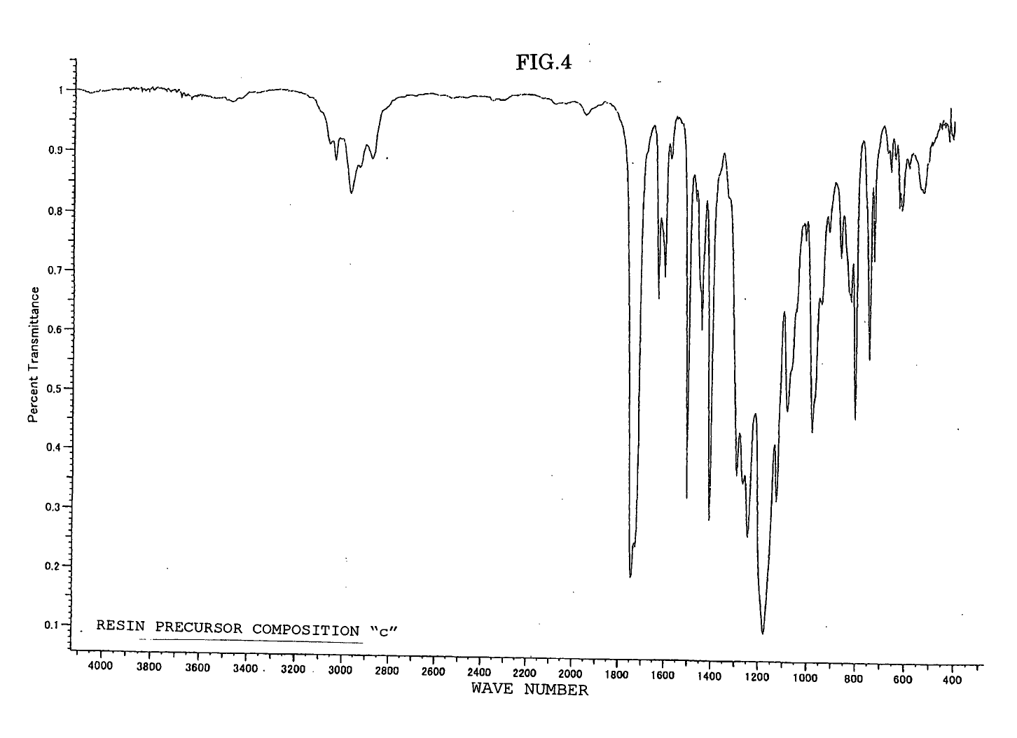

FIG. 4 is an IR spectrum of the resin precursor composition “c”.

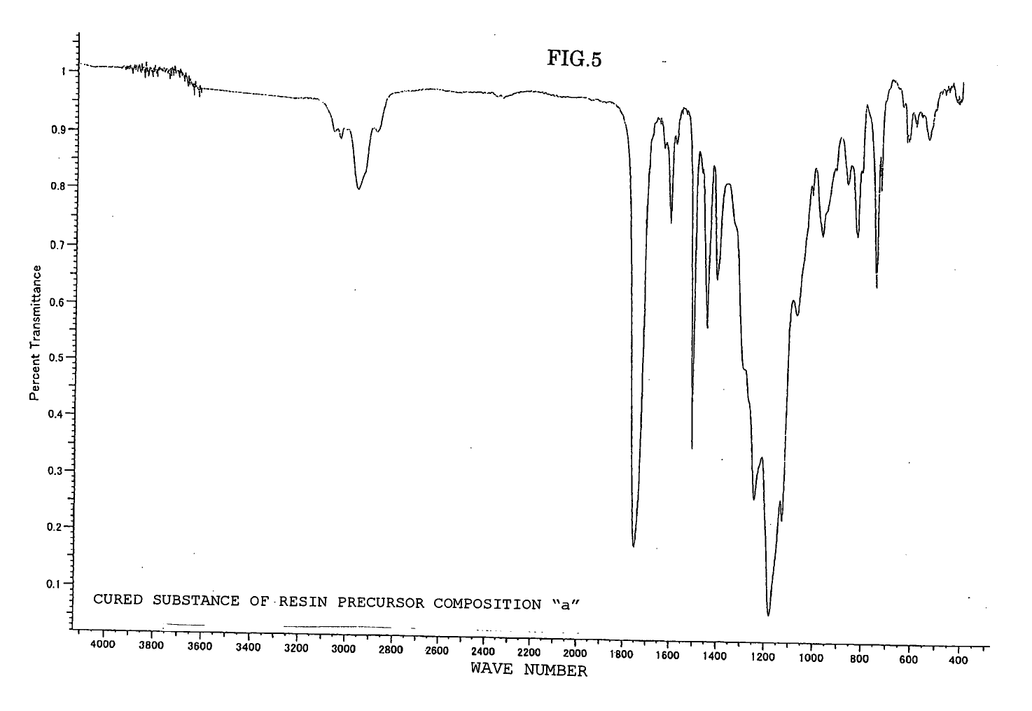

FIG. 5 is an IR spectrum of the cured substance of the resin precursor composition “a”.

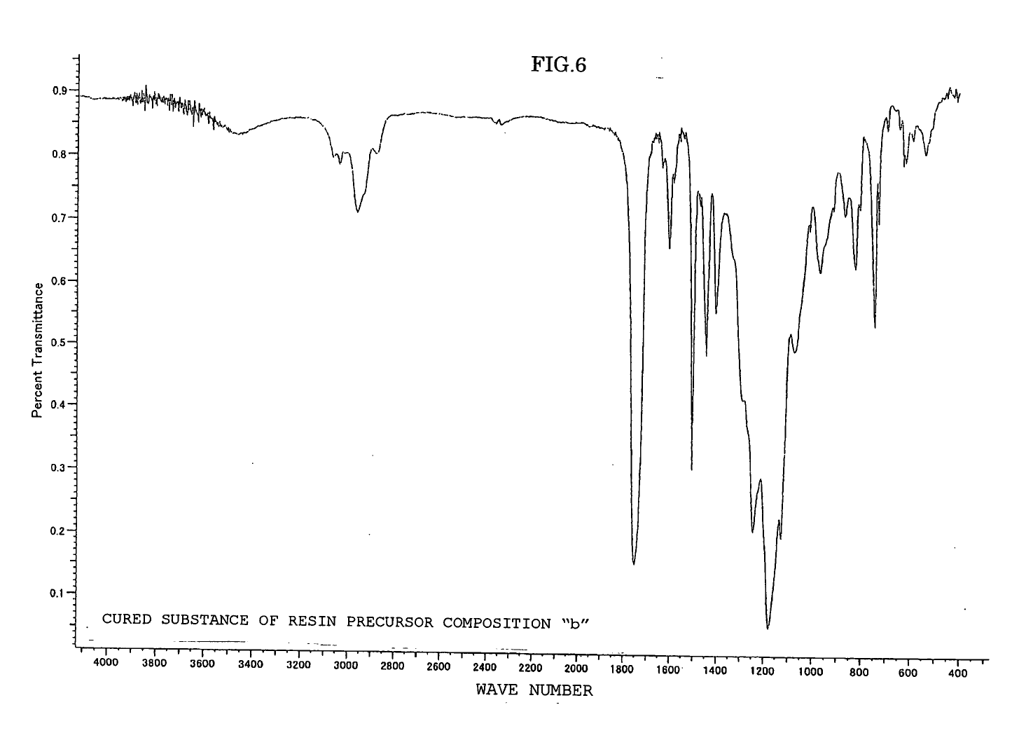

FIG. 6 is an IR spectrum of the cured substance of the resin precursor composition “b”.

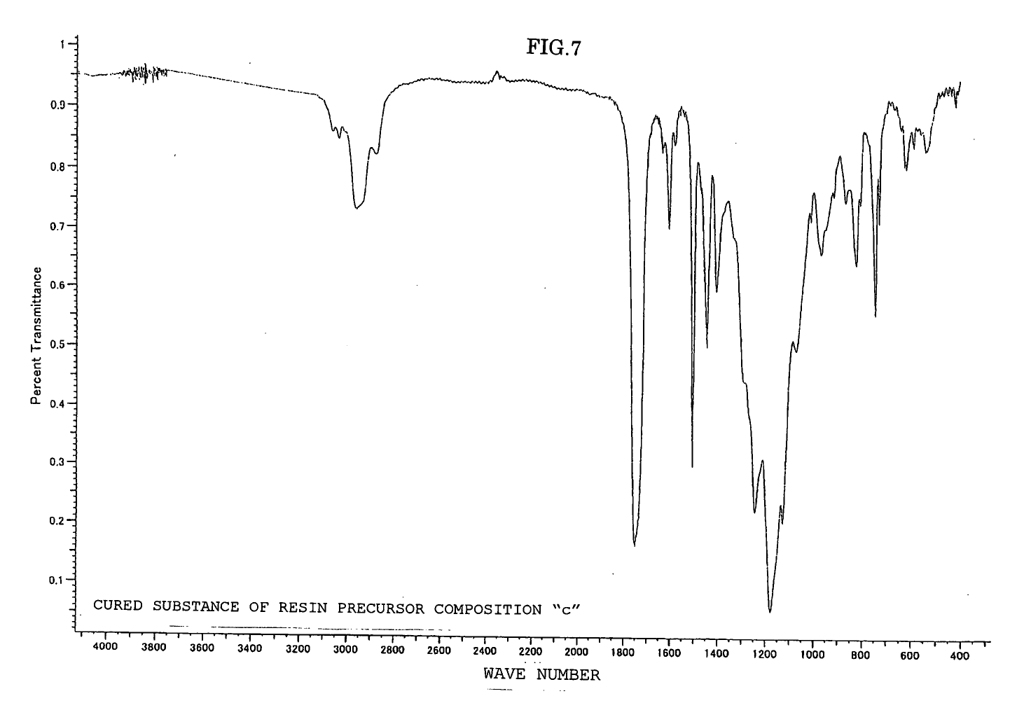

FIG. 7 is an IR spectrum of the cured substance of the resin precursor composition “c”.

According to the present invention, a close-contact multi-layer type diffractive optical element having a low-refractive-index and high-dispersion resin layer that is optically homogeneous can be produced.

1. A close-contact multi-layer type diffractive optical element, comprising:
two optical members that are in close contact with each other; and
an interface between the optical members constituting a diffraction grating,
wherein one of the optical members is made of a first resin that is a cured substance of a first resin precursor composition containing bifunctional fluorine-containing acrylate and/or bifunctional fluorine-containing methacrylate, bifunctional acrylate having a fluorene structure and/or bifunctional methacrylate having a fluorene structure, and a photopolymerization initiator.

2. A close-contact multi-layer type diffractive optical element according to claim 1, wherein the other of the optical members is made of a second resin that is a cured substance of a second resin precursor composition containing an acrylate-terminated oligomer obtained by allowing excess bifunctional acrylate to react with bifunctional thiol, and the photopolymerization initiator.

3. A close-contact multi-layer type diffractive optical element according to claim 1, wherein:
a refractive index n_{d} of the first resin is at most 1.54; and
an mean dispersion (n_{F}−n_{C}) of the first resin is at least 0.0145.

4. A close-contact multi-layer type diffractive optical element according to claim 1, wherein:
a refractive index n_{d} of the second resin is at least 1.55; and
an mean dispersion (n_{F}−n_{C}) of the second resin is at most 0.013.

5. A close-contact multi-layer type diffractive optical element according to claim 1, wherein:
total content of the bifunctional fluorine-containing acrylate and the bifunctional fluorine-containing methacrylate, of the first resin precursor composition, is 10 to 80 wt %; and
total content of the bifunctional acrylate having a fluorene structure and the bifunctional methacrylate having a fluorene structure, of the first resin precursor composition, is 10 to 80 wt %.

6. A close-contact multi-layer type diffractive optical element according to claim 1, wherein the first resin precursor composition further comprises (meth)acrylate copolymerizable with the bifunctional fluorine-containing acrylate and/or the bifunctional fluorine-containing methacrylate, and the bifunctional acrylate having a fluorene structure and/or the bifunctional methacrylate having a fluorene structure.

7. A resin precursor composition, comprising:
bifunctional fluorine-containing acrylate and/or bifunctional fluorine-containing methacylate;
bifunctional acrylate having a fluorene structure and/or bifunctional methacrylate having a fluorene structure; and
a photopolymerization initiator.

8. A UV-cured resin obtained by curing a resin precursor composition, wherein the resin precursor composition comprising:
bifunctional fluorine-containing acrylate and/or bifunctional fluorine-containing methacylate;
bifunctional acrylate having a fluorene structure and/or bifunctional methacrylate having a fluorene structure; and
a photopolymerization initiator.

9. An acrylic resin which is a copolymer having a first repetition unit represented by the following general formula (Chemical Formula 1a) and a second repetition unit represented by the following general formula (Chemical Formula 1b): 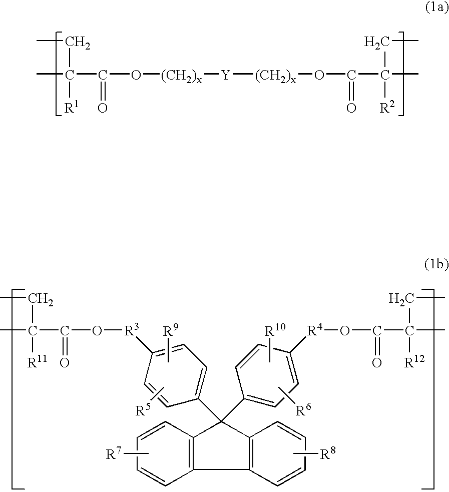
where R¹ and R² each represent a hydrogen atom or a methyl group, R³ and R⁴ each represent —((CH₂)ₚO)ₘ— or —(CH₂CH(OH)CH₂O)ₘ— (where m represents an integer of 1 to 3, and p represents an integer of 2 to 4), R⁵ to R¹⁰ each represent a hydrogen atom, a fluorine atom, a hydrocarbon group containing 1 to 6 carbon atoms, a phenyl group, a phenyl fluoride group, and a phenyl group with a hydrocarbon group containing 1 to 6 carbon atoms substituted, and R¹¹ to R¹² each represent a hydrogen atom or a methyl group, x represents an integer of 1 to 2, and Y represents a perfluoroalkyl group containing 2 to 12 carbon atoms or —(CF₂—O—CF₂)_{z}—, where z represents an integer of 1 to 4.

10. A resin precursor composition for a close-contact multi-layer type diffractive optical element, wherein:
a refractive index n_{d} of a cured resin is at most 1.54; and
an mean dispersion (n_{F}−n_{C}) of the cured resin is at least 0.0145.

11. A UV-cured resin for a close-contact multi-layer type diffractive optical element, wherein:
a refractive index n_{d} is at most 1.54; and
an mean dispersion (n_{F}−n_{C}) is at least 0.0145.

12. A resin precursor composition for a close-contact multi-layer type diffractive optical element, wherein:
a refractive index n_{d} of a cured resin is at most 1.54; and
an mean dispersion (n_{F}−n_{C}) of the cured resin is at least 0.0145.

13. A close-contact multi-layer type diffractive optical element according to claim 2, wherein:
a refractive index n_{d} of the first resin is at most 1.54; and
an mean dispersion (n_{F}−n_{C}) of the first resin is at least 0.0145.

14. A close-contact multi-layer type diffractive optical element according to claim 2, wherein:
a refractive index n_{d} of the second resin is at least 1.55; and
an mean dispersion (n_{F}−n_{C}) of the second resin is at most 0.013.

15. A close-contact multi-layer type diffractive optical element according to claim 3, wherein:
a refractive index n_{d} of the second resin is at least 1.55; and
an mean dispersion (n_{F}−n_{C}) of the second resin is at most 0.013.

16. A close-contact multi-layer type diffractive optical element according to claim 2, wherein:
total content of the bifunctional fluorine-containing acrylate and the bifunctional fluorine-containing methacrylate, of the first resin precursor composition, is 10 to 80 wt %; and
total content of the bifunctional acrylate having a fluorene structure and the bifunctional methacrylate having a fluorene structure, of the first resin precursor composition, is 10 to 80 wt %.

17. A close-contact multi-layer type diffractive optical element according to claim 3, wherein:
total content of the bifunctional fluorine-containing acrylate and the bifunctional fluorine-containing methacrylate, of the first resin precursor composition, is 10 to 80 wt %; and
total content of the bifunctional acrylate having a fluorene structure and the bifunctional methacrylate having a fluorene structure, of the first resin precursor composition, is 10 to 80 wt %.

18. A close-contact multi-layer type diffractive optical element according to claim 4, wherein:
total content of the bifunctional fluorine-containing acrylate and the bifunctional fluorine-containing methacrylate, of the first resin precursor composition, is 10 to 80 wt %; and
total content of the bifunctional acrylate having a fluorene structure and the bifunctional methacrylate having a fluorene structure, of the first resin precursor composition, is 10 to 80 wt %.

19. A close-contact multi-layer type diffractive optical element according to claim 2, wherein the first resin precursor composition further comprises (meth)acrylate copolymerizable with the bifunctional fluorine-containing acrylate and/or the bifunctional fluorine-containing methacrylate, and the bifunctional acrylate having a fluorene structure and/or the bifunctional methacrylate having a fluorene structure.

20. A close-contact multi-layer type diffractive optical element according to claim 3, wherein the first resin precursor composition further comprises (meth)acrylate copolymerizable with the bifunctional fluorine-containing acrylate and/or the bifunctional fluorine-containing methacrylate, and the bifunctional acrylate having a fluorene structure and/or the bifunctional methacrylate having a fluorene structure.

21. A close-contact multi-layer type diffractive optical element according to claim 4, wherein the first resin precursor composition further comprises (meth)acrylate copolymerizable with the bifunctional fluorine-containing acrylate and/or the bifunctional fluorine-containing methacrylate, and the bifunctional acrylate having a fluorene structure and/or the bifunctional methacrylate having a fluorene structure.

22. A close-contact multi-layer type diffractive optical element according to claim 5, wherein the first resin precursor composition further comprises (meth)acrylate copolymerizable with the bifunctional fluorine-containing acrylate and/or the bifunctional fluorine-containing methacrylate, and the bifunctional acrylate having a fluorene structure and/or the bifunctional methacrylate having a fluorene structure.
